(19) United States
(12) Patent Application Publication
(10) Pub. No.: US 2017/0097247 A1
(43) Pub. Date: Apr. 6, 2017

(54) SENSOR ASSEMBLY WITH AN ENCODER DISC

(71) Applicant: Schaeffler Technologies AG & Co. KG, Herzogenaurach (DE)

(72) Inventors: Carsten Ohr, Charlotte, NC (US); Brian Lee, York, SC (US)

(73) Assignee: SCHAEFFLER TECHNOLOGIES AG & CO. KG, Herzogenaurach (DE)

(21) Appl. No.: 14/873,299

(22) Filed: Oct. 2, 2015

(51) Int. Cl. G01D 5/20

(52) U.S. Cl. CPC G01D 5/2013

(57) ABSTRACT

A sensor assembly with an inductive sensor and a marking ring that is rotatably mountable is provided. The marking ring is spaced apart from and aligned with the inductive sensor, and includes a non-ferrous body and a ferrous material ring that is located at least partially within the non-ferrous body and adapted to pass in proximity to the inductive sensor upon rotation of the marking ring. The ferrous material ring includes protrusions that vary non-uniformly in at least one of spacing, distance from the inductive sensor to a facing portion of the ferrous material ring, or mass, in a circumferential direction around the marking ring. The inductive sensor detects a rotational angle position of the marking ring based on the protrusions of the ferrous material ring as they pass the inductive sensor.

### FIELD OF INVENTION

The present invention relates to an arrangement used to detect torque, an angular speed, and/or a rotary position of a shaft or bearing ring.

### BACKGROUND

Bearing arrangements including sensors for detecting a rotational position of the bearing are known. The detected rotational position can be used along with other data to determine an angular speed as well as torque. Known position sensors for bearing arrangements can use an optical rotary encoder. Recently, it has also been proposed to use an inductive sensor and a marking ring or encoder disc including a wavy surface comprised of a ferrous material. The inductive sensor detects a rotational angle position of a shaft or bearing ring connected to the marking ring based on a proximity of the wavy surface to the inductive sensor. Due to the projections and valleys along the wavy surface of the marking ring, the marking ring can collect debris or contaminants, causing interference in the magnetic flux between the ferrous marking ring and the inductive sensor, which can result in less accurate or incorrect position readings. It would be desirable to provide a simple way to prevent the marking ring from collecting debris and contaminants. Known examples of rotary position sensors by the inventors which are assigned to the same assignee as the present invention and address this issue are explained in detail in U.S. patent application Ser. No. 14/744,428 , filed Jun. 19, 2015, and Ser. No. 14/676,920 , filed Apr. 2, 2015 , both of which are incorporated herein by reference as if fully set forth.

Although these prior improvements have been successful, it would be desirable to provide an encoder disc of this type for use in an angular position sensor with further reduced cost, reduced weight, and ease of manufacture.

### SUMMARY

A sensor assembly with a simplified configuration that prevents contaminants from adhering to a marking ring and is simpler and/or more economical to produce is provided. The sensor assembly includes an inductive sensor and a marking ring that is rotatably mountable. The marking ring is spaced apart from and aligned with the inductive sensor, and includes a non-ferrous body and a ferrous material ring that is located at least partially within the non-ferrous body and adapted to pass in proximity to the inductive sensor upon rotation of the marking ring. The ferrous material ring includes protrusions that vary non-uniformly in at least one of a spacing, a distance from the inductive sensor to a facing portion of the ferrous material ring, or mass, in a circumferential direction around the marking ring. The inductive sensor detects a rotational angle position of the marking ring based on the protrusions of the ferrous material ring as they pass the inductive sensor.

In one aspect, the marking ring is connected to at least one of a shaft or a bearing ring.

In another aspect, the ferrous material ring is continuous and may vary in cross section.

In another aspect, the non-ferrous body is made of polymeric material. The non-ferrous body is preferably molded or cast about the ferrous material ring. This allows for light weight as well as low cost production, for example by injection or insert molding.

In another aspect, the inductive sensor is located along a radial edge of the marking ring. Alternatively, the inductive sensor is located along an axial region of the marking ring.

A method for manufacturing a sensor assembly is also provided. The method includes: forming protrusions on a strip of ferrous material; rolling the strip of ferrous material into a ring; and embedding the ring in a non-ferrous body. Alternatively, the ring can be formed by stamping out rigs with the desired profile and/ or cutting sections of an extruded profile.

In another aspect, one end portion of the ferrous material ring is attached to a second end portion of the ring, preferably by welding.

In another aspect, the non-ferrous body is made up of a polymeric material.

### BRIEF DESCRIPTION OF THE DRAWING(S)

The foregoing Summary and the following detailed description will be better understood when read in conjunction with the appended drawings, which illustrate a preferred embodiment of the invention. In the drawings:

FIG. 1A shows a front plan view of a sensor assembly according to a first embodiment.

FIG. 1B is a cross-sectional view along line 1B-1B in FIG. 1A.

FIG. 1C shows a side view of the sensor assembly of FIG. 1A.

FIG. 2A shows a plan view of a sensor assembly according to a second embodiment.

FIG. 2B shows a cross-sectional view along line 2B-2B in FIG. 2A.

FIG. 2C shows a side view of the sensor assembly of FIG. 2A.

FIG. 3 shows a ferrous material strip prior to any manufacturing.

FIG. 4 shows a ferrous material strip that is preformed with protrusions.

FIG. 5 shows a ferrous material ring with protrusions that has been rolled.

FIG. 6 shows an embodiment of a ferrous material ring in which the ends are connected.

FIG. 7A shows a front view of a sensor assembly according to a third embodiment.

FIG. 7B is a cross-sectional view along line 7B-7B of FIG. 7A.

FIG. 7C is a cross-sectional view along line 7C-7C of FIG. 7A.

FIG. 8 is a front view of a sensor assembly according to a fourth embodiment.

### DETAILED DESCRIPTION OF THE PREFERRED EMBODIMENT(S)

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as, for example, “ at least one of a or b” (where a and b represent the items being listed) means any single one of the items a or b, or a combination of a and b. This would also apply to lists of three or more items in like manner so that individual ones of the items or combinations thereof are included. The terminology includes the words specifically noted above, derivatives thereof and words of similar import.

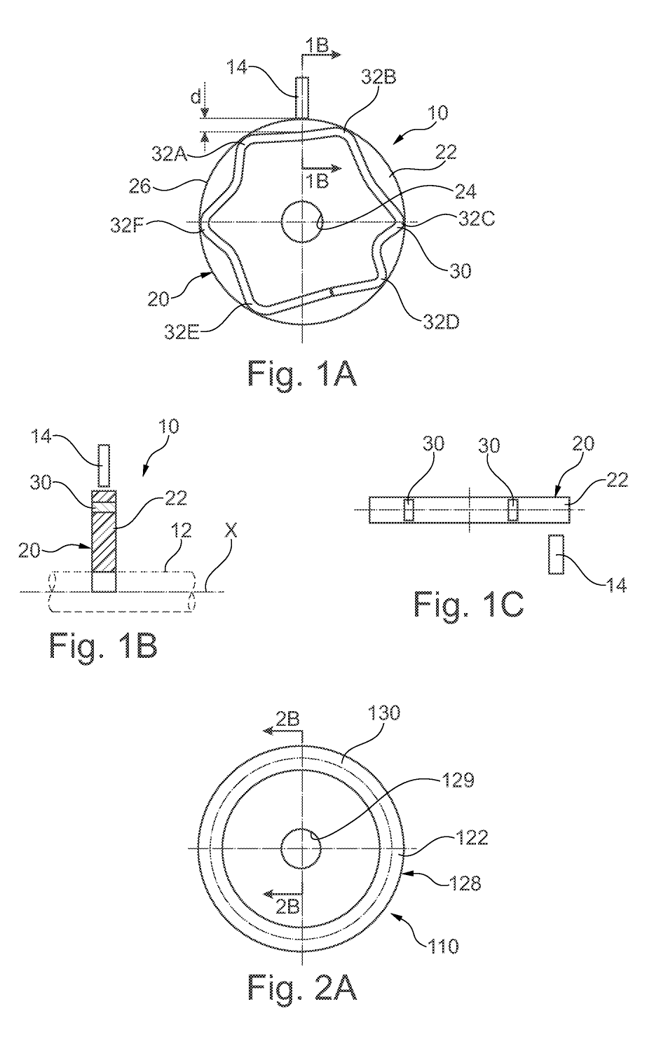

Referring to FIGS. 1A-1C, a first embodiment of a sensor assembly 10 is shown. The sensor assembly 10 includes an inductive sensor 14 and a marking ring 20. The sensor assembly 10 may be rotatably mounted to a shaft 12 or bearing ring (not shown). As the shaft 12 rotates about an axis X, the position is detected using the inductive sensor 14 which is aligned with the marking ring 20 that is connected to the at least one shaft 12 or bearing ring. The marking ring 20 is spaced apart from and aligned with the inductive sensor 14. In the first embodiment shown in FIGS. 1A-1C, the sensor 14 is radially aligned with a circumferential edge 26 of the marking ring 20.

As shown in detail in FIGS. 1A and 1B, the marking ring 20 includes a non-ferrous body 22, preferably formed of a non-magnetic, more preferably polymeric, material. The non-ferrous body 22 also preferably includes an opening 24 for the shaft 12.

As shown in FIGS. 1A-1C, a ferrous material ring 30 is at least partially, and preferably completely, embedded in the non-ferrous body 22 and extends about the periphery. The ferrous material ring 30 in the marking ring 20 is adapted to pass in proximity to the inductive sensor 14 upon rotation of the marking ring 20. As shown in detail in FIGS. 1A and 1B, in the first embodiment of the sensor assembly 10, the ferrous material ring 30 includes protrusions 32A-32F that vary non-uniformly in at least one of a distance from the inductive sensor 14 to a facing portion of the ferrous material ring 30, or in mass, in a circumferential direction around the marking ring 20. In the first embodiment, the continuous ferrous material ring 30 has a constant cross section and accordingly, the mass is generally constant at any given position in a circumferential direction. However, the distance d shown in FIG. 1A varies depending upon the radial height the projection 32A-32F.

Preferably, the ferrous material ring 30 is continuous; however, it could have a break at a seam location to the extent that the ferrous material ring 30 is formed from a continuous strip of material according to a preferred method of the invention. This method is illustrated in FIGS. 3-6 in which the strip of material 30A is shown in FIG. 3 without any of the protrusions being formed. In FIG. 4, the strip 30B is shown with the protrusions 32A-32F being initially formed. As shown in FIG. 5, the ferrous material ring 30 is formed with the protrusions 32A-32F in their final configuration based on rolling of the strip 30B having the protrusion profiles formed therein into a continuous ring 30. This ring 30 can then have the ends connected together or welded at seam 16 as shown in FIG. 6. The ferrous material ring 30 is then imbedded in the non-ferrous body 22, preferably by casting or insert molding. The non-ferrous body 22 preferably is cylindrical in form with a constant outside diameter.

In the preferred embodiment, the ferrous material ring 30 is formed of iron and the non-ferrous body 22 is formed of a suitable polymeric material. However, other fill material could be used for the non-ferrous body 22. Additionally, while the embodiment in FIGS. 1A-1C as well in FIGS. 5 and 6 shows six protrusions 32A-32F, the spacing, number, and size of the protrusions can be varied, depending upon the accuracy required for the inductive sensor assembly 10. The inductive sensor 10 detects a rotational angle position of the marking ring 20 based on the protrusions 32A-32F of the ferrous material ring 30 passing the inductive sensor 14, and the magnetic flux changing depending on the variance in spacing, distance, or mass of the protrusions 32A-32F on the ferrous material ring 30 in proximity to the sensor 14.

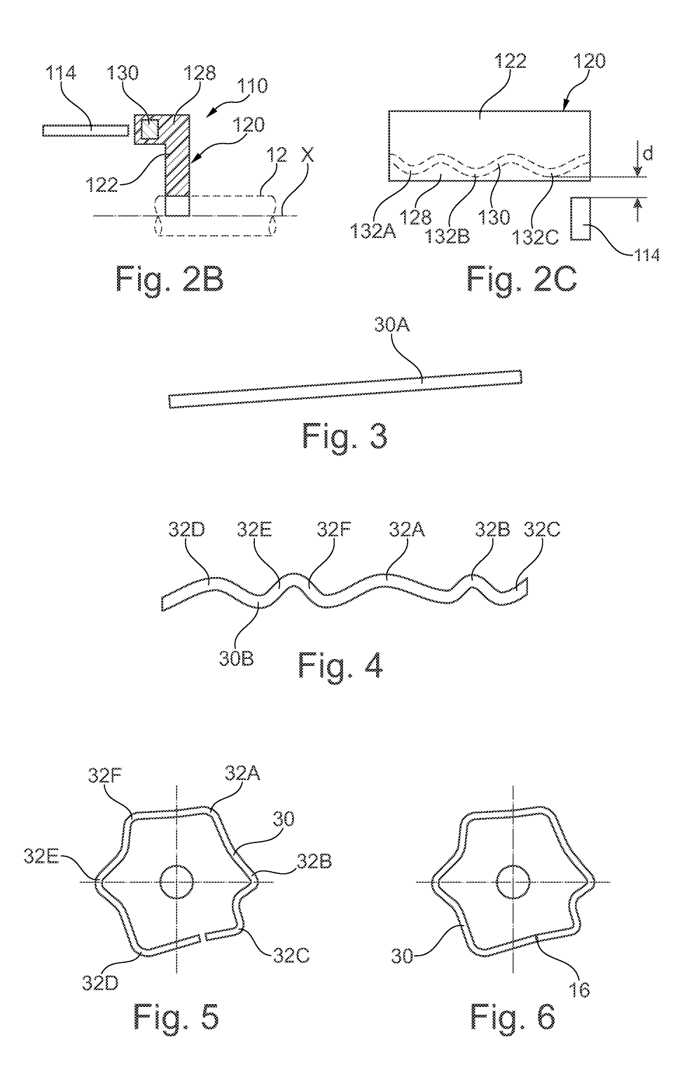

The embodiment of the sensor assembly shown in FIGS. 1A-1C shows the arrangement of the sensor assembly 10 with the inductive sensor 14 located at a radial edge of the marking ring 20. However, as shown in the second embodiment of the sensor assembly 110 in FIGS. 2A-2C, the inductive sensor 114 can be located along an axial region of the marking ring 120.

In the second embodiment of the sensor assembly 110, the marking ring 120 is shown mounted on the shaft 12 in order to rotate the axis X. Here the marking ring 120 includes a non-ferrous body 122 that extends radially and connects to an axial flange 128 at a periphery thereof. The non-ferrous material ring 130 is located in the axial flange 128 and is preferably formed in a similar manner to the ferrous material ring 30 noted above with the protrusions extending in an axial direction of the ring rather than in a radial direction. The inductive sensor 114 is located along an axial region of the marking ring 120 and, as indicated in FIG. 2C, the distance d between the inductive sensor 114 and the protrusions 132A-132C, shown in FIG. 2C, varies depend upon a rotational position of the marking ring 120. Again, the distance and spacing of the protrusions 132A-132C, etc. in the circumferential direction can vary, with in this case the protrusion height varying in the axial direction, while the period or spacing of the protrusions 132A-132C preferably varies in the circumferential direction.

In addition to the possibility of forming the ferrous material ring 130 in a similar manner to the ferrous material ring 30 discussed above by initially forming protrusions on a strip of ferrous material, and then rolling the ferrous material strip into a ring 130 prior to imbedding the ring in the non-ferrous body 122, preferably by casting or insert molding, it would also be possible to stamp the ring 130 from a sheet of ferrous material having the desired thickness. In this case, it is also possible to vary the distance from the inductive sensor 114 to a facing portion of the marking ring 120 or a mass of ferrous material ring 130 in the circumferential direction, or both by either providing the ferrous material ring 130 with a constant cross-section based on a constant thickness and radial width of the ferrous material ring 130, or by varying the mass by varying a width in cross-section of the ring 130 while the thickness remains constant. This in combination with varying the height of the protrusions 132A-132C, etc. can provide additional functionality in the sensor assembly 110.

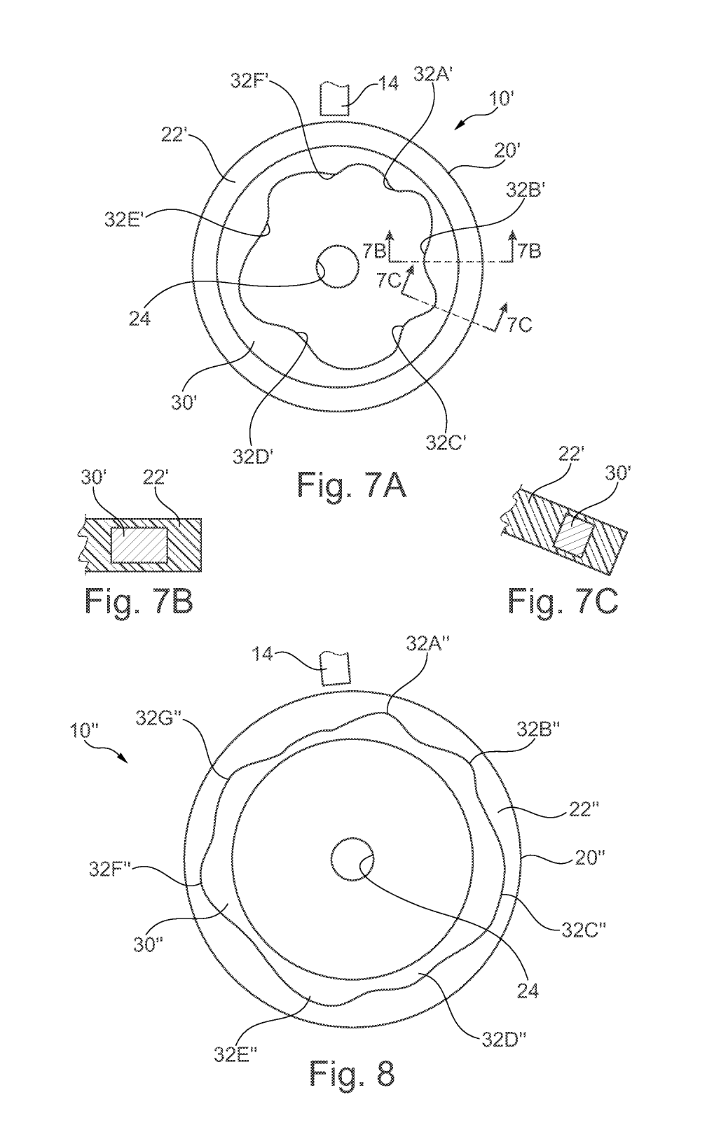

Referring to FIGS. 7A-7C, a further alternate embodiment of the sensor assembly 10′ is shown which is similar to the first embodiment of the sensor assembly 10 shown in FIGS. 1A-1C. Here, the ferrous material ring 30′ is formed with a constant outer diameter and a varying inner diameter in order to provide a ferrous material ring 30′ having protrusions 32A′-32F′ with a spacing and a mass that varies in a circumferential direction about the marking ring 20′. This is shown in detail in FIGS. 7B and 7C where the cross-sectional width in the radial direction of the ferrous material ring 30′ varies. Accordingly, while the distance from the inductive sensor 14 would remain the same, the mass varying in the circumferential direction about the marking ring 30′ allows the rotational angle position of the marking ring to be detected by the inductive sensor based on the location of the changes in mass caused by the inwardly directed protrusions changing the ring mass in the circumferential direction about the marking ring 30′. Here the inwardly directed protrusions are indicated as 32A′-32F′.

In this case, the ferrous material ring 30′ can be formed by stamping a ferrous material sheet or by forming a strip with the protrusions and then rolling the strip into a ring 30′ prior to imbedding the ring 30′ in the non-ferrous body 22′.

Referring to FIG. 8, a further alternative embodiment of the sensor assembly 10″ is shown. The embodiment of the sensor assembly 10″ is similar to the embodiments 10 and 10′ discussed above. However, in this case the protrusions on the ferrous material ring 30″ of the marking ring 20″ extend radially outwardly from a constant internal diameter of the ferrous material ring 30″. In this case, the circumferential spacing, the distance from the inductive sensor 14, as well as the mass vary non-uniformly in a circumferential direction around the marking ring 20″. In this case, protrusions 32A″-32G″ are shown.

In addition to the processes described above for forming the ferrous material rings 30, 30′, 30″, 130, would also be possible to provide a profiled ferrous material extrusion having the desired shape and cutting or slicing rings off of the constant cross-section extrusion in order to form the ferrous material rings 30, 30′, 30″ in an economic manner.

Those skilled in the art will recognize that the number of protrusions as well as the cross-section of the ring 30, 30′, 30″, 130 can be changed depending upon the particular application and sensitivity required for the rotational angle position location provided by the sensor assembly 10, 10′, 10″, 110. Further, by providing the ferrous material ring as a single part including protrusions that vary non-uniformly in at least one of (a) the spacing, (b) the distance from the inductive sensor 14, 114 to a facing portion of the ferrous material ring 30, 30′, 30″, 130, or (c) the mass in the circumferential direction around the marking ring 20, 20′, 20″, 120, the assembly of the marking ring 20, 20′, 20″, 120 with the non-ferrous body 22, 22′, 22″, 122 becomes much more economical by insert molding a single part within the non-ferrous body.

A method of detecting a rotational angle position of at least one shaft 12 or bearing ring is also provided. Here, an inductive sensor 14, 114 is located adjacent to a marking ring 20, 20′, 20″, 120, connected to the least one shaft 12 or bearing ring. The marking rings 20, 20′, 20″, 120 are as described above. A rotational angle positon of the at least one shaft 12 or bearing ring is detected based on an inductive field variance due to at least one of the spacing, the distance d or the mass of the protrusions on the ferrous material ring 30, 30′, 30″, 130 varying as they pass the inductive sensor 14, 114.

The present position sensors allow for reduced manufacturing cost and lower weight by preferably molding the non-ferrous body with a single ferrous material ring located therein, allowing for easier positioning of the ring in the mold. Customization of the inductive field variance to be measured is easily achieved with low cost and greater flexibility through use of the variably spaced and/or sized protrusions for the ferrous material rings in the embodiments described.

Having thus described the presently preferred embodiments in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiments and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A sensor assembly, comprising:
an inductive sensor;
a marking ring rotatably mountable in a position spaced apart from and aligned with the inductive sensor, the marking ring includes a non-ferrous body and a ferrous material ring located at least partially within the non-ferrous body adapted to pass in proximity to the inductive sensor upon rotation of the marking ring; and
the ferrous material ring includes protrusions that vary non-uniformly in at least one of (a) spacing, (b) distance from the inductive sensor to a facing portion of the ferrous material ring, or (c) mass, in a circumferential direction around the marking ring,
wherein the inductive sensor detects a rotational angle position of the marking ring based on the protrusions of the ferrous material ring as they pass the inductive sensor.

2. The sensor assembly of claim 1, wherein the marking ring is connected to at least one of a shaft or a bearing ring.

3. The sensor assembly of claim 1, wherein the ferrous material ring is continuous.

4. The sensor assembly of claim 3, wherein a cross section of the ferrous material ring varies.

5. The sensor assembly of claim 1, wherein the non-ferrous body is made of a polymeric material.

6. The sensor assembly of claim 5, wherein the non-ferrous body material is molded or cast about the ferrous material ring.

7. The sensor assembly of claim 1, wherein the inductive sensor is located along a radial edge of the marking ring.

8. The sensor assembly of claim 1, wherein the inductive sensor is located along an axial region of the marking ring.

9. The sensor assembly of claim 8, wherein the ferrous material ring is a stamped ring.

10. A method for manufacturing a sensor assembly comprising:
forming protrusions on a strip of ferrous material;
rolling the strip of ferrous material into a ring; and
embedding the ring in a non-ferrous body.

11. The method of claim 10, wherein the non-ferrous body is comprised of a polymeric material.

12. The method of claim 10, wherein a first end portion of the ring is attached to a second end portion of the ring.
